(19) United States
(12) Patent Application Publication
(10) Pub. No.: US 2008/0155646 A1
(43) Pub. Date: Jun. 26, 2008

(54) Rights Object, Rights Object Issuing Method, and Contents Controlling Method Using the Same in Digital Rights Management

(76) Inventor: Seung-Jae Lee, Gyeonggi-Do (KR)

Correspondence Address: BIRCH STEWART KOLASCH & BIRCH, PO BOX 747, FALLS CHURCH, VA, 22040-0747, US

(21) Appl. No.: 11/911,709

(22) PCT Filed: May 23, 2006
(86) PCT No.: PCT/KR2006/001930

§ 371 Date: Oct. 16, 2007

(30) Foreign Application Priority Data
Jun. 29, 2005 (KR) 10-2005-0057336

(51) Int. Cl. G06F 21/00

(52) U.S. Cl. 726/1

(57) ABSTRACT

Provided are a rights object, a rights object issuing method, and a contents controlling method using the same, wherein when a Digital Rights Management (DRM) having received a request for operating a certain content receives a rights object including pre-use constraint information with respect to another content in order to use the corresponding certain content, the DRM agent operates the corresponding content if every operation designated in the pre-use constraint information or at least one or more of the operations are performed to thus satisfy the constraint.

### TECHNICAL FIELD

The present invention relates to a Digital Rights Management (DRM), and more particularly, to a rights object having a condition that other contents should first be used, a rights object issuing method, and a contents controlling method using the same.

### BACKGROUND ART

In general, a Digital Rights Management (DRM), which is a mechanism for stably protecting and systematically managing rights for digital assets, prevents contents piracy, achieves rights objects, and provides a series of protection and management system in the process of generating, distributing and using contents.

FIG. 1 is a view illustrating a configuration of a related art DRM system.

As illustrated in FIG. 1, a related art DRM system regulates a content which a contents provider has transferred to a user to be used by a rights object which has been issued to the user. Here, the contents provider refers to an entity corresponding to a Content issuer (CI) and/or a Rights Issuer (RI).

The CI issues contents (referred to as DRM contents hereafter) which are protected by use of certain encryption keys in order to protect the DRM contents from a user who does not have a right for an access to the DRM contents, and the RI issues Rights Objects (ROs) which are required to use the DRM contents.

A DRM agent is mounted in a terminal to receive the DRM contents and the ROs from the CI and the RI, and analyzes permission and/or constraint included in the ROs, thereby regulating the use of the DRM contents in the corresponding terminal.

The DRM agent transfers the DRM contents received from the CI to other DRM agents or transfers them to a local storage unit or a network storage unit in order to store the DRM contents therein. The DRM agents having received the DRM contents receives the ROs with respect to each of the corresponding DRM contents from the RI.

The other DRM agents having received the DRM contents and/or the ROs with respect to the corresponding DRM contents uses the received DRM contents within a range defined by the permission and/or constraint included in each of the ROs. Here, the operation of transferring the DRM contents and the ROs with respect to the corresponding DRM contents to the other DRM agents is defined as ‘export’. Each of the ROs with respect to the corresponding DRM contents may include various types of constraints which are applied for using the corresponding DRM contents. The various types of restrictions may, for example, include the number of times, time, system, or the like, for using the corresponding contents.

However, the related art DRM system does not provide an RO which includes a concept that another content must first be used in order to use one content. That is, there is no way in the related art DRM system to represent a constraint which indicates that another content must first be used in order to use the one content.

### DISCLOSURE OF INVENTION

### Technical Problem

Therefore, it is an object of the present invention to provide a Rights object, a rights object issuing method, and a contents controlling method using the same in a Digital Rights Management (DRM), by which a condition that another content must first be used in order to use a content provided by a contents provider can be included in a rights object.

### Technical Solution

To achieve this object of the present invention, there is provided a rights object in a Digital Rights Management (DRM) comprises pre-use constraint information which indicates that another content must first be used in order to use a certain content.

To achieve this object of the present invention, there is also provided a rights object issuing method in a Digital Rights Management (DRM) comprising: generating, by a rights issuer, a rights object including pre-use constraint information which indicates that another content must first be used in order to use a certain content; receiving, in a DRM agent, a signal for obtaining the rights object from a content issuer; and requesting and receiving, by the DRM agent, the corresponding rights object from the rights issuer.

To achieve this object of the present invention, there is also provided a contents controlling method in a Digital Rights Management (DRM) comprising: receiving a request for an operation of a certain content from a user by a DRM agent which has received at least one content and a rights object with respect to the corresponding content; confirming, by the DRM agent, a rights object with respect to the certain content requested; if the rights object includes pre-use constraint information which indicates that another content must first be operated in order to execute the requested content, satisfying the pre-use constraint information, by the DRM agent, and then operating the corresponding content.

To achieve this object of the present invention, there is also provided a Digital Rights Management (DRM) system comprising: a content issuer for issuing at least one or more contents; a rights issuer for issuing a rights object including pre-use constraint information which indicates that another content must first be used; and a DRM agent for confirming the rights object including the pre-use constraint information received from the rights issuer and controlling the use of a requested certain content when a user requests for the use of the certain content received from the content issuer.

To achieve this object of the present invention, there is also provided a mobile communications terminal employing a Digital Rights Management (DRM) comprising a DRM agent for receiving at least one or more contents from a content issuer and receiving a rights object for each of the contents from a rights issuer, wherein when a user requests for the use of a certain content, the DRM agent confirms whether the received rights object includes pre-use constraint information which indicates that another content must first be used, to thereby control the use of the requested content.

### DESCRIPTION OF DRAWINGS

FIG. 1 is a view illustrating a configuration of a typical digital rights management system;

FIG. 2 is a view illustrating a configuration of general rights elements;

FIGS. 3 and 5 are exemplary views illustrating elements which are additionally defined according to the present invention;

FIGS. 4 and 6 are exemplary views respectively illustrating embodiments of rights objects according to the present invention; and

FIG. 7 is a signal flowchart illustrating a contents implementing method using the rights object shown in FIG. 4.

### MODE FOR INVENTION

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Hereinafter, explanation will now be given for embodiments for a rights object, a rights object issuing method, and a contents controlling method using the rights object in a DRM system according to the present invention with reference to the attached drawings.

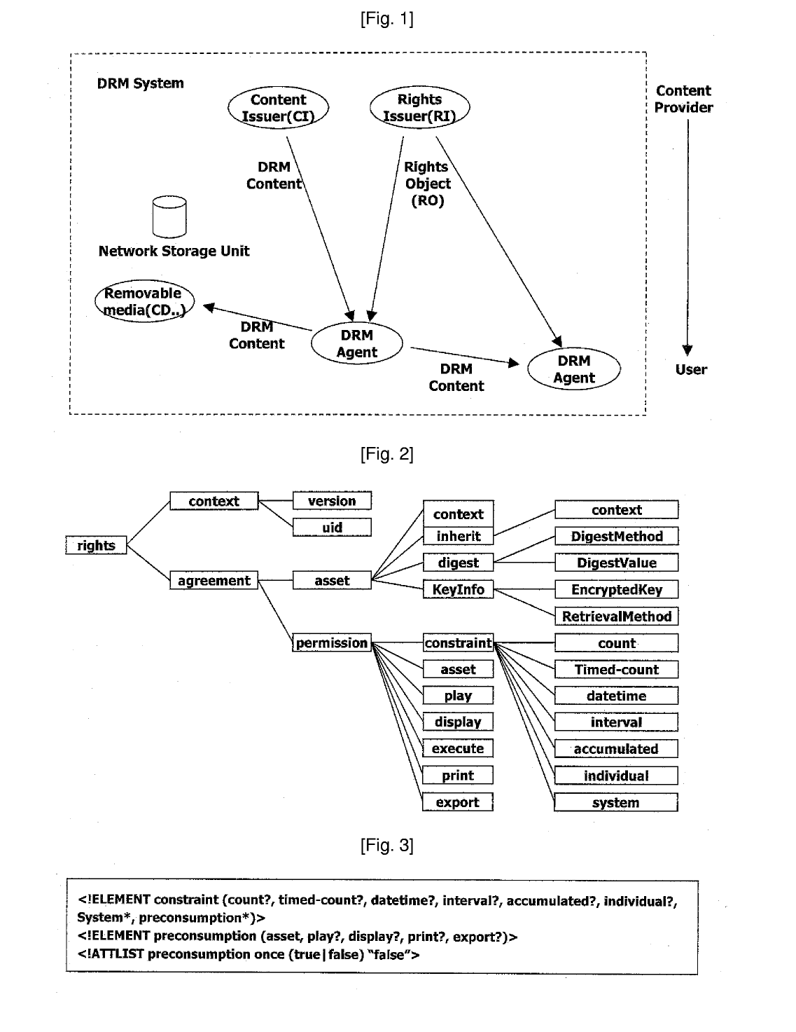

The DRM system illustrated in FIG. 1 is applied to the rights object, the rights object issuing method, and the contents controlling method using the same according to the present invention.

In the present invention, a Content issuer (CI) issues at least one or more contents, and a Rights Issuer (RI) issues a Rights Object (RO) including pre-use constraint information which indicates that another contents must first be used, so as to variously define the order or the number of times of using a plurality of contents which are consecutively operated.

In the present invention, when a user requests for the use of a certain content, a DRM agent confirms an RO including pre-use constraint information which has been received from the RO, to thereby control the use of the requested content. Preferably, the controlling refers to a controlling of the order or the number of times of using contents based upon the pre-use constraint information.

In addition, the DRM agent can be applied to terminals and systems related to a mobile communication, and can also be adapted to other wireless communication systems which use mobile devices such as Personal Digital Assistants (PDAs), laptop computers, and the like having characteristics related to wireless communication.

FIG. 2 is a view illustrating a configuration of rights elements which are formats for defining ROs.

As illustrated in FIG. 2, first, rights elements may include a context element for providing meta data for a corresponding right, and an agreement element for describing a right granted for a certain DRM content. The context element may include a version element indicating a version of an RO, and a uid element for configuring an ID of the RO. In addition, the agreement element may include one or more asset elements for embodying an identity of a DRM content which is affected by the corresponding agreement element, and a permission element for enumerating constraints with respect to operations which are permitted to the terminal, wherein no permission element may exist or one or more permission elements may exist.

The asset element may have an attribute indicating a DRM contents identifier and/or a reference identifier which are/is affected by the corresponding agreement element. The asset element may include a digest element including hash values which are used for confirming an integrity of the corresponding DRM content, and the like.

The permission element includes elements such as constraint, asset, play, display, print, export, and the like. The constraint element indicates a condition which is adapted to operations of all of the display, export, and the print elements which are subordinate elements belonging to the permission element. The asset element which is the subordinate element belonging to the permission element indicates an asset to which the operations of the subordinate elements belonging to the permission element are to be applied.

That is, when a user performs operations such as playing, displaying, exporting, printing, or the like for the DRM content, the operations may be restricted by constraints within the RO, for example, the constraint element, and the asset element which is the subordinate element belonging to the permission element.

FIGS. 3 and 5 are exemplary views illustrating elements which are additionally defined to rights elements according to the present invention, wherein the rights elements were represented in a manner of Extensible Markup Language Document Type Definition (XML DTD), however, which may not be limited thereto.

As illustrated in FIGS. 3 and 5, the constraint element may include a pre-consumption element which is newly defined in the present invention as well as elements such as count, timed-out, datetime, interval, accumulated, individual, system, and the like.

The present invention especially defines an RO including a constraint (referred to as a pre-use constraint) which indicates that another content must first be used in order to use a certain content. In the embodiments according to the present invention, in order to describe the pre-use constraint, the preconsumption element is added to the constraint element as its subordinate element, but the position thereof is not limited thereto.

As illustrated in FIG. 3, the constraint element may have no preconsumption element or include one or more preconsumption elements. In the case that the constraint element includes one or more preconsumption elements, an operation designated with respect to an asset which every preconsumption element regards must first be performed.

As illustrated in FIG. 5, in addition, the preconsumption element may have no subordinate element, or include one or more consumptionunit elements as its subordinate element. Here, in the case that the preconsumption element includes one or more consumptionunit elements, when an operation designated with respect to an asset, which at least one or more consumptionunit elements regards, is first performed, it is regarded as a condition required by the corresponding preconsumption element has been satisfied.

Here, before performing the operation designated in the preconsumption element (refer to FIG. 3) or the consumptionunit element (refer to FIG. 5), the DRM agent can receive a user confirmation with respect to whether to perform the corresponding operation. That is, depending on the user's response with respect to whether to perform the designated operation, the DRM agent can allow the performance of the operation which the preconsumption element (refer to FIG. 3) or the consumptionunit element (refer to FIG. 5) has designated, or can prohibit the use itself of the certain content requested by the user.

The preconsumption element or the consumptionunit element may include a child element for representing which operation should be performed with respect to a certain asset, and an attribute for defining the number of time of performing the operation.

Hereinafter, explanation will be given with reference to FIG. 3 and the same explanation cab be applied to the part in FIG. 5 corresponding thereto, whereby a further explanation for FIG. 5 will be omitted.

The preconsumption element describes which operation should be performed with respect to a certain asset, which includes one asset element and at least one operation element. Here, the operation element may include elements such as play, display, print, export, and the like, which may, however, not be limited. Any element which can represent an operation of an asset to be performed may rather be available. Here, the number of each of the elements (i.e., play, display, print, export, etc.) may be zero or one. That is, each of the elements can selectively exist.

The asset element which belongs to the preconsumption element as its subordinate element may include only an idref attribute which indicates a reference identifier of another content for which a designated operation must first be performed, among attributes of the typical asset element.

The DRM element should confirm whether several operations designated in the subordinate elements belonging to the preconsumption element have been performed for the another content. Here, whether the operations have been performed can be confirmed by a usage record of contents which is stored in a certain storage space existing within a terminal in which the DRM agent is disposed.

The preconsumption element has an once attribute with respect to the number of times of operations. The once attribute may have a ‘true’ value and a ‘false’ value. In case of omitting the once attribute, the once attribute value is considered as ‘false’. When the once attribute value is ‘true’, the preconsumption element is performed once, whereas when the once attribute value is ‘false’, the preconsumption element is performed whenever a condition is satisfied. Here, a terminal in which the pre-consumption element is performed may preferably store whether the operation of the preconsumption element has been performed in the storage space.

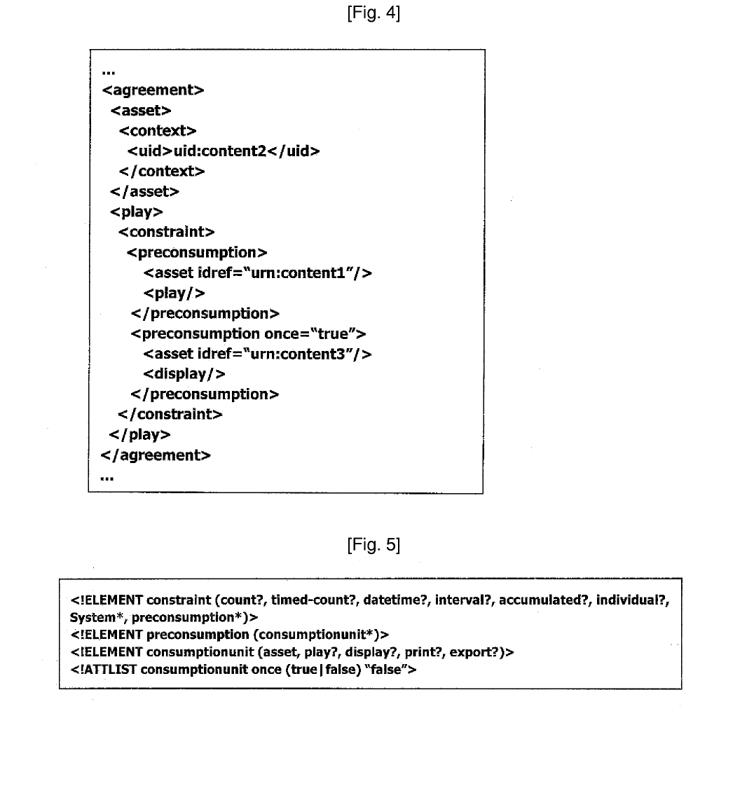

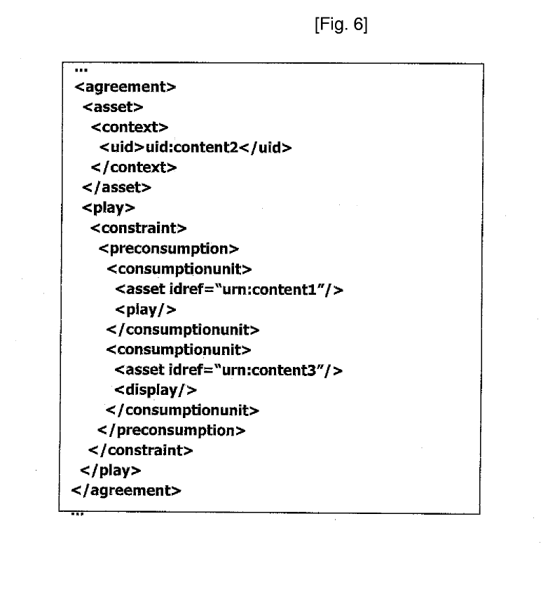

FIGS. 4 and 6 are exemplary views illustrating embodiments of an RO according to the present invention.

As illustrated in FIG. 4, the RO uses the preconsumption element to represent that a content 1 and a content 2 should sequentially be displayed in order to play a content 2.

As illustrated in FIG. 6, the RO uses the preconsumption element to represent that the content 1 should be played or the content 3 should be displayed in order to play the content 2.

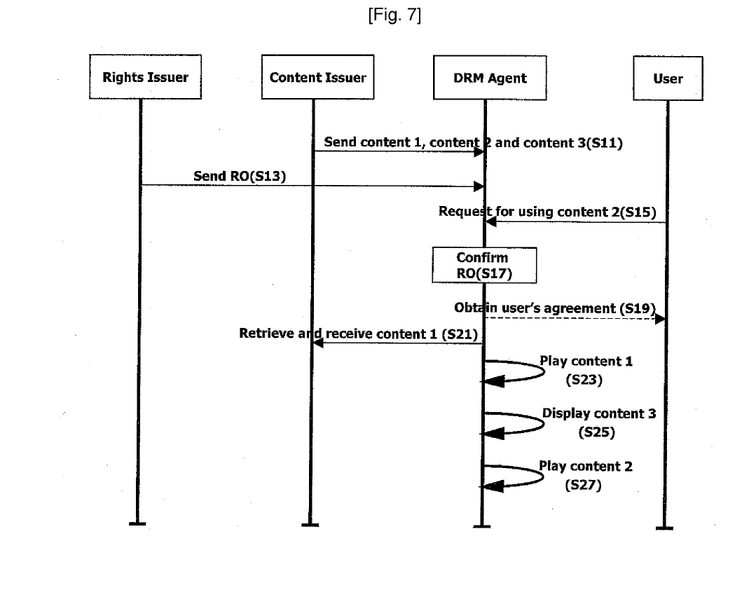

FIG. 7 is a signal flowchart illustrating a contents implementing method using the RO shown in FIG. 4, which illustrates a process for playing a content 2.

First, the DRM agent receives contents 1 through 3 transmitted from the CI (S11), and receives ROs for using each of the contents 1 through 3 from the RI (S13). The RO, as illustrated in FIG. 4, includes a constraint which indicates that the content 1 and the content 3 should be displayed in order to play the content 2.

A process for issuing the RO by the RI will now be briefly explained.

The RI generates an RO by interacting with the CI, and thereafter generates a Rights Object Acquisition Protocol (ROAP) trigger for starting to obtain the RO to then send the generated RO to the CI.

The CI having received the ROAP trigger sends the corresponding ROAP trigger to the DRM agent. The DRM agent requests the RO from the RI and then downloads the RO. Here, the RO includes pre-use constraint information which indicates that the content 1 should be played and the content 3 should be displayed in order to play the content 2.

Afterwards, when a user requests for playing a certain content (S15), the DRM agent confirms a detail (contents) within the received RO (S17) to control the playing for the requested content 2. That is, if it is confirmed that the RO includes the pre-use constraint information, the DRM agent plays the content 1 and displays the content 3, to thereafter play the content 2. If it is confirmed that the RO does not include the pre-use constraint information, the DRM agent plays the requested content 2.

Furthermore, the DRM agent confirms the detail within the received RO. The DRM agent then notifies the user that the content 1 and the content 3 should first be used in order to use the content 2, and queries whether the user agrees with the detail within the RO (S19).

When the user agrees with the detail within the RO, the DRM agent plays the content 1. Here, if the content 1 is linked to the CI, the DRM agent retrieves and receives the content 1 from the CI (S21) and then plays the content 1 (S23).

When the content 1 is completely played, the DRM agent displays the content 3 and then plays the content 2 (S27). Here, each operation is executed as it is set in the permission element and the constraint element of each asset. That is, since the once attribute value of the preconsumption element is ‘true’, the content 3 is displayed once and thereafter is not displayed again in order to play the content 2.

As described above, the present invention can be effective such that the RO including a condition that another content must first be used can be issued and the use of a certain content can be controlled by use of the RO, so as to be able to variously define the order or the number of times of using the content.

In addition, the present invention can be effective such that the use of contents can variously be systemized by making the user first view advertisement in order to use a content requested thereby or by defining the order of using a plurality of contents which are consecutively operated.

1. A rights object in a digital rights management including pre-use constraint information which indicates that another content should first be used in order to use a certain content.

2. The rights object of claim 1, wherein the pre-use constraint information includes:
information for identifying the another content; and
at least one operation information for defining an operational format of the corresponding pre-use constraint information.

3. The rights object of claim 2, wherein the operation information denotes information for representing a designated operation of an asset, which indicates operations such as play, display, print, export, etc.

4. The rights object of claim 1, wherein the pre-use constraint information includes an attribute for defining the number of times for applying the corresponding pre-use constraint information.

5. The rights object of claim 4, wherein the attribute describes whether to apply the corresponding pre-use constraint information once or to apply the pre-use constraint information whenever using the certain content.

6. A rights object issuing method in a Digital Rights Management (DRM) comprising:
generating, by a rights issuer, a rights object including pre-use constraint information which indicates that another content should first be used in order to use a certain content;
receiving, in a DRM agent, a signal for obtaining the rights object from a content issuer; and
requesting and receiving, by the DRM agent, the corresponding rights object from the rights issuer.

7. The method of claim 6, wherein the pre-use constraint information includes:
information for identifying the another content; and
at least one operation information for defining an operational format of the corresponding pre-use constraint information.

8. The method of claim 6, wherein the operation information denotes information for representing a designated operation of an asset, which indicates operations such as play, display, print, export, etc.

9. The method of claim 6, wherein the pre-use constraint information includes an attribute for defining the number of times for applying the corresponding pre-use constraint information.

10. The method of claim 9, wherein the attribute represents whether to apply the corresponding pre-use constraint information once or to apply the pre-use constraint information whenever using the certain content.

11. A contents controlling method in a Digital Rights Management (DRM) in a method for controlling a contents use by receiving at least one content and a rights object with respect to the corresponding content respectively from a content issuer and a rights issuer, the method comprising:
receiving a request for using a certain content from a user;
confirming a rights object of the requested content; and
controlling the use of the requested content according to the confirmation.

12. The method of claim 11, wherein the controlling of the use of the content comprises:
when the rights object includes pre-use constraint information, first operating a content which is designated in the corresponding pre-use constraint information and then operating the requested content; and
when the rights object does not include the pre-use constraint information, operating the requested content.

13. The method of claim 11, wherein the operating of the content comprises:
obtaining, by the DRM agent, a user's agreement with the performance of the pre-use constraint information.

14. The method of claim 11, wherein the pre-user constraint information includes:
information for identifying the another content; and
at least one operation information for defining an operational format of the corresponding pre-use constraint information.

15. The method of claim 14, wherein the operation information denotes information for representing a designated operation of an asset, which indicates operations such as play, display, print, export, etc.

16. The method of claim 11, wherein the pre-use constraint information includes an attribute for defining the number of times for applying the corresponding pre-use constraint information.

17. The method of claim 16, wherein the attribute represents whether to apply the corresponding pre-use constraint information once or to apply the pre-use constraint information whenever using the certain content.

18. A Digital Rights Management (DRM) system comprising:
a content issuer for issuing at least one or more contents;
a rights issuer for issuing a rights object including pre-use constraint information having a condition that another content should first be used; and
a DRM agent for confirming the rights object including the pre-use constraint information having received from the rights issuer and thus controlling a requested certain content when a user requests for using the certain content received from the content issuer.

19. The system of claim 18, wherein the pre-use constraint information includes:
information for identifying the another content; and
at least one operation information for defining an operational format of the corresponding pre-use constraint information.

20. The system of claim 18, wherein the operation information denotes information for representing a designated operation of an asset, which indicates operations such as play, display, print, export, etc.

21. The method of claim 18, wherein the pre-use constraint information includes an attribute for defining the number of times for applying the corresponding pre-use constraint information.

22. The rights object of claim 21, wherein the attribute represents whether to apply the corresponding pre-use constraint information once or to apply the pre-use constraint information whenever using the certain content.

23. The system of claim 18, wherein when the rights object includes the pre-use constraint information, the DRM agent first operates a content designated in the corresponding pre-use constraint information and then operates the requested content.

24. The system of claim 18, wherein the DRM agent controls the order or the number of times of using contents.

25. A mobile communications terminal comprising:
a Digital Rights Management (DRM) agent for receiving at least one or more contents from a content issuer and receiving a rights object for each of the contents from a rights issuer,
wherein when a user requests for using a certain content, the DRM agent confirms whether the received rights object includes pre-use constraint information including a condition that another content should first be used to thus control the use of the requested content.

26. The terminal of claim 25, wherein the DRM agent controls the order or the number of times of using contents.

27. The terminal of claim 25, wherein the pre-user constraint information includes:
information for identifying the another content; and
at least one operation information for defining an operational format of the corresponding pre-use constraint information.

28. The terminal of claim 27, wherein the operation information denotes information for representing a designated operation of an asset, which indicates operations such as play, display, print, export, etc.

29. The terminal of claim 25, wherein the pre-use constraint information includes an attribute for defining the number of times for applying the corresponding pre-use constraint information.

30. The terminal of claim 29, wherein the attribute represents whether to apply the corresponding pre-use constraint information once or to apply the pre-use constraint information whenever using the certain content.

31. The terminal of claim 25, wherein when the rights object includes the pre-use constraint information, the DRM agent first operates a content designated in the corresponding pre-use constraint information and then operates the requested content.
